(19) United States
(12) Patent Application Publication
(10) Pub. No.: US 2012/0206758 A1
(43) Pub. Date: Aug. 16, 2012

(54) METHOD, SYSTEM AND COMPUTER PROGRAM FOR GENERATING AUTHENTICATED DOCUMENTS

(76) Inventors: Thomas Matthew Mann Gibson, TORONTO (CA); John Henry David Wiltshire, Toronto (CA); Graham George Coote, Aurora (CA); Ravi Vipool Balmukund Dave, Toronto (CA); Martin John Warren, Toronto (CA); Lisa Anne Steinbrecher, Toronto (CA); Donna April Kinoshita, Newmarket (CA)

(21) Appl. No.: 13/390,798

(22) PCT Filed: Aug. 17, 2010
(86) PCT No.: PCT/CA10/01255

§ 371 Date: May 2, 2012

Related U.S. Application Data
(60) Provisional application No. 61/234,417, filed on Aug. 17, 2009.

(51) Int. Cl. G06K 15/02

(52) U.S. Cl. 358/1.14

(57) ABSTRACT

The present invention is an apparatus, system and computer program for generating documents that may be validated and authenticated. A hand-writing system may be utilized to produce a replica of handwriting. Such handwriting system may be capable of generating a replica of handwriting that is biometrically accurate in accordance with a specific person's handwriting. The handwriting system may facilitate the integration of a replica of handwriting with one or more documents. The handwriting system may be linked to a printing output device whereby a replica of handwriting may be applied to a document printed by the printer. The handwriting system may incorporate a handwriting tool that may be integrated with the printer so that a replica of handwriting may be facilitated by the handwriting tool during the course of printing a document. Security may be incorporated in the integration of the printer and handwriting system whereby the integration of the handwriting and the document may be unalterable.

### FIELD OF INVENTION

This invention relates in general to devices and systems used to reproduce or replicate human handwriting and more particularly to the application of such devices and systems with printers.

### BACKGROUND OF THE INVENTION

Increasingly individuals are required to be in contact remotely and to pass verifiable handwritten information between themselves. Presently, prior art methods are applicable to the occasion that two or more individuals correspond remotely to conduct a transaction. Some of these types of prior art methods are directed to financial institutions, such as banks, investment firms, lending companies, or other such businesses. In order to facilitate a transaction involving two or more individuals that are located remotely from each other, the prior art comprises various means of electronic communication to transfer copies of signatures of the individuals, or other verification information. However, these methods do not achieve a reliable or legally binding authentication of the parties who are located remotely from each other but are engaging in a transaction together.

The response in the market place to the requirement that one or more signatures of the one or more individuals involved in a transaction be provided in a transaction is generally to accept faxed copies of signed documents. However, although faxed signatures may be applied in transactions, this workflow choice poses a risk because any of the faxed signatures could prove to be a forgery.

Presently, electronic and digital signatures are gradually becoming more acceptable for business purposes. A signature can be scanned into a computer and then sent via the Internet. Alternatively, a whole contract and signature can be scanned and emailed between parties, or to other interested individuals. Infrastructures based on the use of unique digital signatures such as Public Key Infrastructures (“PKI”) arc well known. The use of electronic signatures can offer speed advantages over faxing. However, electronic signatures can still allow forgeries to occur and additionally electronic signatures do not resolve customer interaction issues. Also, there are problems with the adoption digital signature systems due to the fact that such systems generally require a relatively significant departure from established practices for engaging in financial transactions.

A video conference between two parties engaged in a contract or transaction is a means that some prior art has attempted to use for authentication purposes. For example, one party could sign a contract in full view of the second party via video conference and then either fax, or scan and email, the signed contract to the other party. The second party could then add his or her signature, likely again in full view of the first party via video conference, and send the duly executed document back via fax, or scan and email, to the first party. While this method is relatively quick it still has authentication problems. For example, there is no foolproof means of ensuring the signed document that is faxed or emailed between the parties is the same one that was witnessed as being signed during the video conference. Additionally the video conference method incorporating faxing of documents may involve time lags due to the use of a fax as part of the system.

A variety of pen writing mechanisms have been invented over the years for the purpose of reproducing a signature. Mechanically the designs typically incorporated articulated arms or XY plotter type mechanisms. For example, one of the earlier uses of a pantograph mechanism in a writing reproduction machine is described in U.S. Pat. No. 2,332,511 (Glassman et al.).

Other prior art examples of pen writing mechanism also exist. For example, U.S. Pat. No. 3,733,612 (Huston et al.) teaches a signature reproduction machine that converts the position of a pen with respect to a piece of paper to signals recorded on a magnetic tape. The data stored on the magnetic tape can then be played back to reproduce the writing. Additionally, U.S. Pat. No. 6,425,185 (Regnault et al.) discloses a machine to reproduce writing that is a pantograph. The invention includes a pen lift mechanism.

As another example of prior art, MITSUBISHI™ markets a MELFA™ RP-1AH/3AH/5AH industrial robot having an arm moveable along all points of a surface.

The industrial robot includes a five joint closed link mechanism that incorporates a series of robotic actuators at each joint

### SUMMARY OF THE INVENTION

In one aspect, the present disclosure relates to a system for generating documents that can be validated and/or authenticated, characterized in that the system comprises: at least one computer device configured for: enabling the creation or retrieval of an electronic document, and determining or detecting one or more areas of the electronic document for integration of biometrically accurate handwriting representations of one or more individuals associated with the electronic document for establishing the validation and/or authenticity of the electronic document based on the handwriting of the one or more individuals; and at least one printer linkable to the computer device, the printer incorporating or being further linked to a handwriting device that is operable to apply to paper biometrically accurate handwriting representations, wherein the computer device, the printer, and the handwriting device are integrated so as to enable the printing of the electronic document such that it includes the biometrically accurate handwriting representations for the one or more individuals in the one or more areas of the electronic document, such that a version of the electronic document that can be validated and/or authenticated is printable.

In one aspect, the present disclosure relates to a handwriting system to produce a paper document having one or more biometrically accurate handwriting replicas integrated therein with document content, comprising: at least one printer operable to receive instructions from a computer; and a handwriting tool linked to said at least one printer and operable to receive instructions from said computer to produce said one or more biometrically accurate handwriting replicas upon the paper document, further comprising; a handwriting assembly operable to position and move a handwriting implement to produce marks upon the paper document; and a lifting assembly operable to position and move a writing tablet upon which the paper document may be positioned while the handwriting implement produces marks; whereby the marks produced upon the paper document may be the said one or more biometrically accurate handwriting replicas.

In another embodiment of the present invention, as shown in FIG. 9, a system may be provided for generating documents that can be validated and/or authenticated, characterized in that the system comprises: (a) at least one computer device 52 configured for enabling the creation or retrieval of an electronic document, and determining or detecting one or more areas of the electronic document for integration of biometrically accurate handwriting representations of one or more individuals associated with the electronic document for establishing the validation and/or authenticity of the electronic document based on the handwriting of the one or more individuals; and (b) at least one printer 50 linkable to the computer device, the printer incorporating or being further linked to a handwriting device 54 that is operable to apply to paper biometrically accurate handwriting representations, wherein the computer device, the printer, and the handwriting device are integrated so as to enable the printing of the electronic document such that it includes the biometrically accurate handwriting representations for the one or more individuals in the one or more areas of the electronic document, such that a version of the electronic document that can be validated and/or authenticated is printable.

In another aspect of the invention, the at least one computer device is operable to create and store one or more computer files in which the electronic document and the associated biometrically accurate handwriting representations are linked.

In yet another aspect of the invention, the system is operable to store the one or more computer files to a storage medium, for on-demand retrieval of validated and/or authenticated documents.

In a further aspect of the invention, the system is operable to: (a) establish and/or access one or more parameters for defining whether the document or associated transaction has been finalized; (b) initiate the capture of the handwriting of the one or more individuals based on the parameters; and (c) confirm that the parameters have been met so as to create a version of the electronic document that can validated and/or authenticated.

In a still further aspect of the invention, the one or more computer files arc configured to be unalterable and the storage medium is associated with a trusted intermediary for enabling trusted retrieval of validated and/or authenticated documents, and the printing of such documents in a validated and/or authenticated form.

In another aspect of the invention, the printer is a secure printer. For example, the printer may be configured so as to: (a) detect one or more attempts to tamper with the printer, and (b) based on such detection prevent the printing of validated and/or authenticated documents.

In a still other aspect of the invention, the biometrically accurate handwriting representations are printable in ink.

In another aspect of the invention, biometrically accurate handwriting representations may be printed in a color that is distinct from the color of the other portions of the electronic document.

In a further aspect of the invention, each handwriting representation is forensically verifiable as emanating from a single one of the one or more individuals.

In another aspect of the invention, the printer disclosed is a standard printing output device that integrates the handwriting device.

In yet another aspect of the invention, the at least one computer device is further operable to associated with the one or more computer files a symbol, watermark or other indicia indicating that the associated electronic document can be validated and/or authenticated.

In a still other aspect of the invention, the one or more computer files are configured such that when the electronic document is printed, the printed copy includes the indicia.

In another aspect of the invention, the system is a transaction system that incorporates or is linked to the one or more computer of the invention, so as to enable the processing of transactions based on the electronic documents that can be validated and/or authenticated.

In yet another aspect of the invention, a handwriting system is provided, to produce a paper document having one or more biometrically accurate handwriting replicas integrated therein with document content comprising: (a) at least one printer operable to receive instructions from a computer; and (b) a handwriting tool linked to said at least one printer and operable to receive instructions from said computer to produce said one or more biometrically accurate handwriting replicas upon the paper document, further comprising; (i) a handwriting assembly operable to position and move a handwriting implement to produce marks upon the paper document; and (ii) a lifting assembly operable to position and move a writing tablet upon which the paper document may be positioned while the handwriting implement produces the marks; wherein the marks produced upon the paper document are the one or more biometrically accurate handwriting replicas.

In yet another aspect of the invention, a method for generating documents that can be validated and/or authenticated, characterized in that the method comprises the steps of: (a) accessing an electronic document that includes or is associated with one or more parameters for defining whether the electronic document or associated transaction has been finalized, and one or more of such parameters includes the incorporation into the electronic document or associating with the electronic document, biometrically accurate handwriting representations of one or more individuals associated with the electronic document or associated transaction; (b) initiating the capture of the handwriting of the one or more individuals based on the parameters, and associating the resulting handwriting representations with the electronic document; and (c) confirming that the parameters have been met so as to create a version of the electronic document that can be validated and/or authenticated.

In another aspect of the invention, a method may permit the electronic document that can be validated and/or authenticated to be accessed and printed on demand by an authorized printer that includes a handwriting device that is operable to mark a paper document with biometrically accurate handwriting representations.

In yet another aspect of the invention a method may permit each handwriting representation to be forensically verifiable as emanating from a single one of the one or more individuals.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a perspective view of the handwriting tool linked to a printer.

FIG. 2 is a perspective view of the handwriting tool.

FIG. 3 is a perspective view of a mounted handwriting assembly.

FIG. 4 is a side view of a mounted handwriting assembly.

FIG. 5 is a top view of a segment of the handwriting implement holder of the handwriting assembly.

FIG. 6 is a sectional view of a configuration of the lifting assembly.

FIG. 7 is a perspective view of the side and lift plates of the lifting assembly.

FIG. 8 is a perspective view of a configuration of the lifting assembly.

FIG. 9 is a system view of a system that is an embodiment of the present invention;

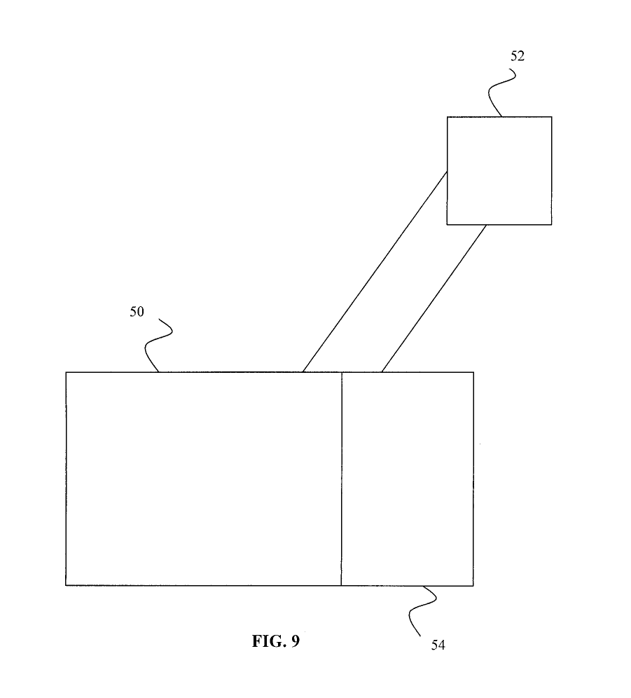

FIG. 10 is a flowchart showing steps of an embodiment of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention may be an apparatus, system, method and computer program for generating documents that may be validated and/or authenticated. In an embodiment of the present invention a handwriting system may be utilized to produce a replica of handwriting. Such handwriting system may be capable of generating a replica of handwriting that is biometrically accurate, in accordance with a specific person's handwriting. The handwriting system may further facilitate the integration of a replica of handwriting with one or more documents. The present invention may also enable the on-demand retrieval of the electronic document that can be validated and/or authenticated. For example, the validation and/or authentication of the electronic document may occur at a date that is later than the generation of the biometrically accurate replica of handwriting by the handwriting system of the present invention.

The system of the present invention may be linked to a printing output device whereby a replica of handwriting may be applied to a document printed by the printer. The handwriting system may incorporate a handwriting tool that may be integrated with the printer so that a replica of handwriting may be facilitated by the handwriting tool during the course of printing a document. Security may be incorporated in the integration of the printer and handwriting system whereby the integration of the handwriting and the document may be unalterable.

In one embodiment of the present invention, an electronic document having one or more biometrically accurate handwriting representations in the document, for example, such that the handwriting is incorporated in the document, the document bears the handwriting, the handwriting is applied to the document, or the handwriting is otherwise associated with the document, may be produced, generated, created or otherwise formed. The document may be immediately validated and/or authenticated, or may be validated and/or authenticated at a date after the document is generated. The document may further be stored to one or more storage areas, for example, such as one or more databases, or one or more electronic or digital storage means. The electronic document may further be easily accessed or retrieved when, and if, validation and/or authentication is required.

In another embodiment of the present invention, a paper copy of the electronic document may be printed on demand- The paper copy of the electronic document may bear one or more biometrically accurate representations of the handwriting of one or more individuals associated with the electronic document, or such individuals that are associated with a transaction.

An embodiment of the present invention that may print the electronic document may incorporate or otherwise be linked to a printing output device. The printing output device may be operable to apply a replica of handwriting to a document printed by the printer.

The handwriting system may incorporate a handwriting tool that may be integrated with the printer so that the system is operable to produce a replica of handwriting through the function of the handwriting tool during the course of printing a document. A skilled reader will recognize that a variety of means of applying handwriting to a printed document may be part of the present invention, such as applying handwriting after the document is printed, or applying handwriting in-line with other sections of the document as the document is printed, or by another means.

In another embodiment of the present invention, security may be incorporated in the integration of the printer and handwriting system. Such incorporation of security may cause the integration of the handwriting and the document may be unalterable. A skilled reader will recognize that the security incorporated in the present invention may be of various types, applications and means.

The present invention may provide a variety of benefits over the prior art. One such benefit of the present invention over the prior art is that the present invention may offer a system and method whereby electronic documents can be generated having biometrically accurate handwriting incorporated in the electronic document, and the electronic document may be validated and/or authenticated at a later date. For example, validation and/or authentication of an electronic document may be required at a date after the date when the biometrically accurate handwriting is incorporated in the document for the purpose of complying with an audit. Another reason why validation and/or authentication may occur at a later date is to respond to a challenge of the validity and/or authenticity of the document, or the validity and/or authenticity of a transaction associated with the document.

In order to respond to such requirements the prior art commonly requires the generation and careful storage of paper versions of documents bearing handwriting, such as, for example signatures of individuals associated with the transactions, whose signatures are witnessed. Validation and/or authentication of the handwriting on the document will require that the paper versions of the documents be located and retrieved from the storage. The validation and/or authentication of the document will involve scrutiny of the handwriting, and the validation and/or authentication may be based on testimony from witnesses or forensic analysis of the handwriting of the individuals. The creation of paper documents beating all necessary handwriting can be a cumbersome and costly task, particularly where the individuals are at different geographic locations. The prior art method generally involves sending the paper document between parties for signature. The storage and retrieval of paper documents may also be cumbersome and costly, due to the space the documents occupy and the necessity to implement a sometimes complex system to keep track of the storage location of all of the paper documents bearing handwriting.

The result of prior art systems can be that significant expense is required to get all the necessary signatures on a paper document, and then to store the paper documents and maintain a storage system that enables retrieval and production of paper documents as needed. The present invention may overcome the costs and cumbersome nature of the prior art systems and methods. It may allow for biometrically accurate handwriting to be incorporated in a document, without requiring the costly transfer of a paper document between parties (or alternatively the cost expended to cause all parties gather in a single location to sign a document). The present invention may further allow for a less costly storage and easy retrieval of a document, for example, such as required for the purpose of validating or authenticating as document (and the handwriting thereon) after the document is stored, because documents may be stored electronically in the present invention. Thus, the present invention may provide a method and system that is less expensive to implement and maintain, and also easier to retrieve documents from. These are significant benefits over the prior art. Other benefits are described later in this patent application.

In one embodiment of the present invention, the handwriting system of the present invention may be operable to reproduce handwriting of one or more individuals and to facilitate the integration of said handwriting with an electronic document and/or a paper document. The handwriting may include a variety of types of handwriting, for example, such as one or more signatures, annotations, or handwritten text of one or more individuals. A skilled reader will recognize that the handwriting may be a wide variety of types and created for a number of purposes. The handwriting may be incorporated in the document in a structured format, such as, for example in a particular location upon a document that is a form. The handwriting may also be incorporated in the document in an unstructured format, for example, such as handwriting on a blank piece of paper.

The paper document may include any document, for example, such as a business document that may require verification and/or authentication of the source of the handwriting and the intention of such handwriting to be integrated and/or affixed to a particular version of the document.

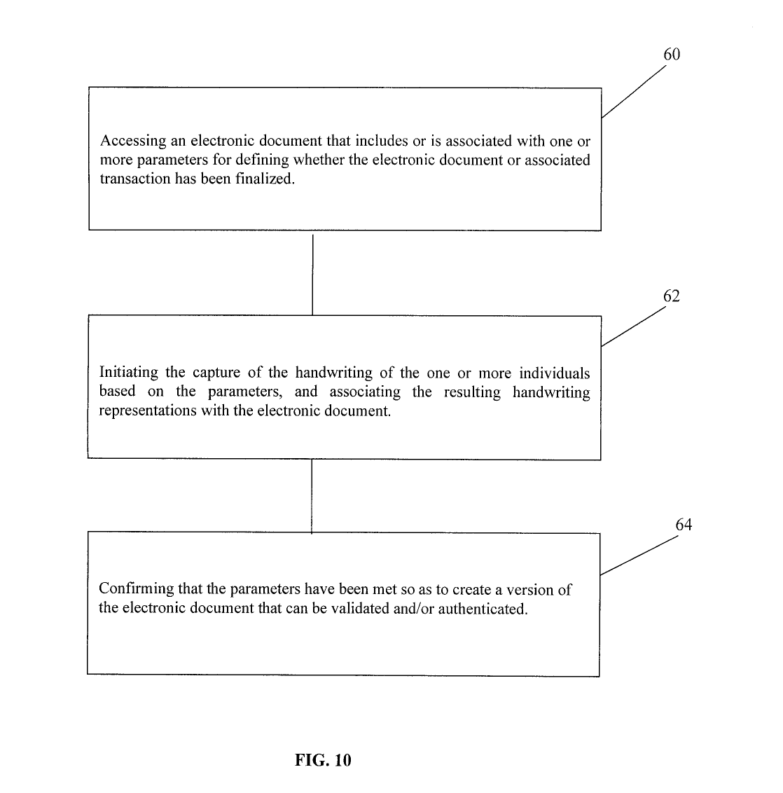

In one embodiment of the present invention, as shown in FIG. 10, a method for generating documents that can be validated and/or authenticated is provided including the steps of: (a) accessing an electronic document that includes or is associated with one or more parameters for defining whether the electronic document or associated transaction has been finalized 60, and one or more of such parameters includes the incorporation into the electronic document or associating with the electronic document, biometrically accurate handwriting representations of one or more individuals associated with the electronic document or associated transaction; (b) initiating the capture of the handwriting of the one or more individuals based on the parameters, and associating the resulting handwriting representations with the electronic document 62; and (c) confirming that the parameters have been met so as to create a version of the electronic document that can be validated and/or authenticated 64.

In such an embodiment of the present invention, the parameters may include: (i) requirements for signing a document, including based on requirements for an associated transaction; (ii) order of signatures; (iii) presentation by individuals required to sign a document of other credentials or passwords; (iv) order of signatures; (v) annotation required of specific portions of the document, such as initialing of specific provisions of an agreement; (vi) confirmation of title of signatories; (vii) confirmation of location of signatories at the time of signature, such as by means of an IP address associated with their computer or other geo-location means; (viii) order of signature if applicable, etc. A skilled reader will understand that many other parameters may be utilized in the present invention. For example, for some individuals a biometrically accurate physical signature may be required, but for others an e-approval or application of an electronic only signature may be used.

The system and method of the present invention may be configured to guide the one or more individuals in the application of the parameters, and in the tracking of which parameters remain unfulfilled. Once all of the parameters have been fulfilled, the present invention may be operable to confirm the fulfillment of the parameters. Upon the fulfillment of the parameters the present invention may generate a final version of the document that can be verified or authenticated, as explained in more detail in this patent application.

In connection with the gathering of the handwriting representations of the one or more individuals, the system may include and or be linked to any form of one or more computer devices, for example, such as a desktop computer, tablet computer, iPad™, or even a mobile device, provided that these incorporate or are linked to an input means for collecting biometrically accurate handwriting data. The input means for collecting biometrically accurate handwriting data may be a variety of input means, for example, such as a digital pen linked to the device for capturing the biometrically accurate handwriting data and other information required to identify the individual.

As an example, the present invention may be utilized to collect biometrically accurate handwriting representations from one or more parties to a contract. In an example that involves multiple parties providing biometrically accurate handwriting representations to be incorporated in a document, for example, such as a contract that requires execution by multiple parties, the biometrically accurate handwriting representations may be provided from a variety of computer devices utilizing a variety of input means. A first party to a contract located in China may provide a handwriting representation necessary to execute the contract by way of a tablet computer utilizing an input means that is a digital pen. The present invention may receive the handwriting representation of the first party and incorporate this handwriting representation into an electronic document that is an executed contract where the first party is required to execute the contract, or is required otherwise to provide handwriting. A second party to a contract located in Canada may provide a handwriting representation necessary to execute the contract by way of a desktop computer by way of an input means that is another device capable of capturing the biometrically handwriting data and other information required to identify the second party. The present invention may receive the handwriting representation of the second party and incorporate this handwriting representation into an electronic document that is an executed contract where the second party is required to execute the contract, or is required otherwise to provide handwriting. A skilled reader will recognize that other third, fourth, etc. parties may also provide handwriting representations from remote locations and the present invention may receive these and incorporate the handwriting representations of each of the parties into the contract where each party is required to include handwriting or otherwise execute the contract. In this manner the contract may be executed in a manner that may be verified and authenticated. A skilled reader will recognize that a variety of documents may have handwriting incorporated therein as necessary.

The computer device may be operable to assemble the electronic document in a form that can be verified and/or authenticated, as described herein. The computer device may be operable to communicate with one or more computers to assemble additional biometrically accurate handwriting data. For example, the computer device may be operable to communicate with one or more computers that are remote computer devices associated with other individuals or parties required to provide handwriting representations, for example, such as a signature, for a particular document, said other individuals or parties being located at one or more remote locations. One or more of the computer devices may include, or be linked, to a computer program for administering the collection of handwriting data and other data for verification and/or authentication of the document, or an associated transaction, in accordance with the parameters.

In one embodiment of the present invention, the computer device includes a server computer that is operable to communicate with one or more other computer devices so as to administer the collection of handwriting data and other data for verification and/or authentication of the document, or an associated transaction, in accordance with the parameters. A skilled reader will appreciated that the server computer may be linked to a server application that includes, or embodies, various functions or features associated with creating a final version of an electronic document, finalizing a transaction having one or more electronic documents associated with the transaction, or otherwise finalizing one or more electronic documents and/or transactions.

In one embodiment of the present invention, the server computer may provide a transaction system. The transaction system may be operable to leverage the creation of electronic documents that can be verified and/or authenticated.

In another embodiment of the present invention, the server computer (or network of server computers) may be linked to a database. The database may be utilized for storing the electronic documents that can be verified and/or authenticated, and/or for retrieval of the electronic documents as required at a date and/or time subsequent to the storage of the electronic documents.

In yet another embodiment of the present invention, the server computer may be linked to the printer of the present invention. The link between the server computer and the printer may provide on-demand access to paper printouts of electronic documents that can be verified and/or authenticated, in accordance with the present invention. These printed documents may include handwriting representations that are forensically verifiable in accordance with one aspect of the invention. It should be understood that the server computer may be associated with a trusted party, such that the server computer acts as a trusted intermediary that may be used to verify and/or authenticate electronic documents or associated transactions. For example a third party, or any other party, seeking confirmation of the authenticity of a document, or any associated legal instrument, may send information necessary to identify the document, or legal instrument, to the trusted party and/or the server computer of the trusted party. The party sending the information may further request verification and/or authentication of the document by the server computer of the trusted party. In embodiments of the present invention, the retrieval of a document, verification of a document, authentication of a document, and/or any other query or activity of the trusted party and/or server computer of the trusted party may be undertaken based on a fee for service and/or a subscription basis.

In one embodiment of the present invention, the server computer may be used as a gateway to enable the printing of verified and/or authenticated documents. The printing may be undertaken by means of linked secure printers located near to the party requesting the printing, for example, such as at the site of an enterprise client.

In another embodiment, the present invention may be implemented as a trusted document or transaction network, implemented by an enterprise client, for example, such as a bank or trust company. The trusted document or transaction network may enable the creation of electronic documents that can be verified and/or or authenticated. The electronic documents that are created may be printed as required in a biometrically accurate fashion so as to generate “original” signed documents on demand. A skilled reader will recognize that despite the enterprise implementation, a remote server may still participate on a document-by-document basis to validate the document or associated workflow, for example, such as to confirm that an approved secure workflow has been followed.

The present invention, by enabling the generation of a verifiable and/or authenticated document, may operate as a transaction system whereby one or more individuals may enter into transactions represented by the document. For example, a patent declaration document may require the signatures of multiple inventors. The present invention may facilitate multiple inventors to integrate or affix their signatures to the document and/or other handwritten details. The present invention may therefore allow all of the inventors to enter into the transaction of providing a patent declaration by each of the inventors providing biometrically accurate handwriting representations to the present invention. The provided signatures may be incorporated into an electronic document that is a patent declaration in the appropriate areas. The electronic document may bear the biometrically accurate signatures of each of the inventors.

An electronic document, or printed document, generated by the present invention, bearing signatures and/or other handwriting representations, may be verifiable and/or authenticate-Ole as each of the handwriting representations and/or signatures incorporated in the electronic or printed document may be determined definitively to be that of the individual that provided a handwriting representation to the present invention because that individual was required to attach his or her signature and/or other handwriting to the document.

A skilled reader will recognize that the present invention may permit for a paper form of the document to be created and printed. The paper form of the document may bear or otherwise include all of the document content and the handwritten comments and/or signatures thereupon. The paper form of the document may be relied upon as a legally binding document. A skilled reader will recognize that a wide variety of documents may exist that can be utilized in the present invention.

The present invention generally provides an apparatus, system, method and computer program for generating documents that may be validated and/or authenticated and may be deemed legally binding.

The present invention may provide a benefit over the prior art in that some prior art permits the creation of documents having handwriting affixed thereto, but in a manner whereby the integration of the handwriting and the document could not be verified and/or authenticated as the document created by the individuals involved in the transaction. The present invention provides a system, method, apparatus and computer program for the creation of a paper document that has handwriting integrated with document content. The integration of these elements of the document may furthermore be verified and authenticated. The document may thereby be confirmed as the version of the document created by the parties. Specifically this process may involve: (i) the handwriting being affirmed as that of the individual required to affix writing to the document; and (ii) verification of the version of the document as the one to which one or more individuals intended to affix their handwriting.

The present invention may provide another benefit over the prior art, in that it may incorporate a workflow to produce a paper copy of a verifiable and authenticated document. A skilled reader will recognize that several workflows may be applied to the present invention. Prior art methods, systems and computer programs fail to apply a means of verifying and/or authenticating the handwriting appearing on a document to be that of a particular individual if there is no witness to the handwriting, or the handwriting is not directly created by the individual putting pen to the paper of the document. The present invention permits the creation of a paper document that is equivalent to an “originally signed copy” of a document. The present invention may incorporate a means of biometrically associating a document with specific individuals who have added handwriting to a document, whether this be a signature, comment or other form of annotation. This may be accomplished through a linking of a biometrically accurate handwriting system to a printer. The handwriting system and printer may be tied to the workflow for generating the verifiable and/or authenticated documents. The result may be that the paper copy of the document is legally enforceable.

The present invention may present yet another benefit over the prior art. Existing prior art pen systems that permit for an individual to affix his or her handwriting to a document remotely generally do not permit the creation of biometrically accurate handwriting to the document that is remote from the individual producing the handwriting. Additionally, prior art does not facilitate the electronic capture of the replica of the handwriting as linked to a specific version of a document to which the handwriting is to be affixed. The present invention permits the document and the handwriting to be stored in a manner whereby the handwriting and the document version the individual intended to affix his or handwriting to are linked. This provides the benefit that a paper copy of the document having the handwriting integrated therein or affixed thereto may be achieved at any time. In a particular aspect of the invention the paper copy of the document may be retrieved electronically and generated as a biometrically accurate paper document on an on-demand basis. If a paper copy is created immediately in accordance with prior art methods then such a document may become lost. The present invention means the document may be stored until a paper copy is required to be created. As a consequence the document cannot become lost during a lapse of time between the affixing of the handwriting to the document and the production of the paper copy of the document.

In one embodiment of the present invention a printer may be linked to a handwriting system that may comprise or embody a workflow for generating validated and/or authenticated documents. Such documents may be stored electronically, for example, such as in a digital format or other format. The printer may be operable to create paper versions of validated and/or authenticated documents. The printer may be a secure printer. A secure printer may be dedicated solely to the creation of paper documents, and/or may facilitate the implementation of security functions and features so as to cause the printer to prohibit any tampering with or alteration of any validated or authenticated document in the process of creating a paper copy thereof. The printer may be a standard laser, bubble jet or other printing output device. A secure printer may be any type of printer modified or affected so as to provide the secure printer of the present invention. A skilled reader will recognize that other types of printers may be utilized and alternate means of achieving a secure printer may be applied.

In one aspect of the invention, the printer may indicate that the validated or authenticated document has been generated based on the workflow described by affixing a watermark or other identifier to the validated or authenticated document.

In another embodiment of the present invention the handwriting system may be a biometrically accurate writing system. Such a handwriting system may be capable of producing a replica of handwriting that is biometrically accurate to the handwriting of a specific person. The handwriting system, which may comprise a system, method and computer program, may enable handwriting to be applied to or integrated with an electronic or paper document remotely located from the person providing the handwriting. The handwriting system may incorporate one or more handwriting tools to affix handwriting to, or integrate handwriting with, a paper document or an electronic document. The handwriting tool and other elements of the handwriting system may be operable by way of a computer or other communication means. The handwriting system and may be integrated with an existing printing output device which may be a secure printer.

Any paper copy of a document created by the handwriting system may be identified as associated with a particular digital document file. This may facilitate a means of viewing an electronic version of the original document. The electronic original document may be compared to the paper copy of the document to ensure that the documents are the same.

The integration of the handwriting system and a printer of the present invention may incorporate a handwriting tool. This handwriting tool may facilitate the integration or affixing of handwriting to a paper copy of the document content as a paper copy of the document is produced. The handwriting tool may therefore produce a replica of handwriting upon the paper document that is in ink. The replica of handwriting may be a biometrically accurate version of the handwriting of an individual, and it is this version of the handwriting that will compose the replica of handwriting.

Generally the creation of the paper document in accordance with the present invention may involve the steps of opening a document from storage. The document may be stored as one or more handwriting replica components and one or more document content components. The whole of the document integrates these components into a format that has been signed off on and agreed upon by all the parties to a transaction. As a consequent the stored version of the document is a replica of an “original document”. The stored document is therefore a verified and authenticated document that may be deemed legally binding.

When a paper copy of the document is created a printer may print the document content whereas a handwriting tool may be utilized to produce the handwriting components of the document. The handwriting tool may facilitate the production of biomechanically accurate handwriting replicas as integrated with the document content. The handwriting replicas may be forensically accurate. For example, the handwriting replicas may represent the nuances of the handwriting of the individual who originally produced the handwriting, such as points of pressure, thickness of lines, cadence of writing, etc.

Should a seal, watermark or other insignia be indicated to be integrated with a handwriting replica, or to replace a handwriting replica, or to otherwise be attached to a document, the printer may produce the seal or other insignia upon the paper document.

Alternatively, the handwriting tool may be operable to produce the seal or other insignia upon the paper copy of the document.

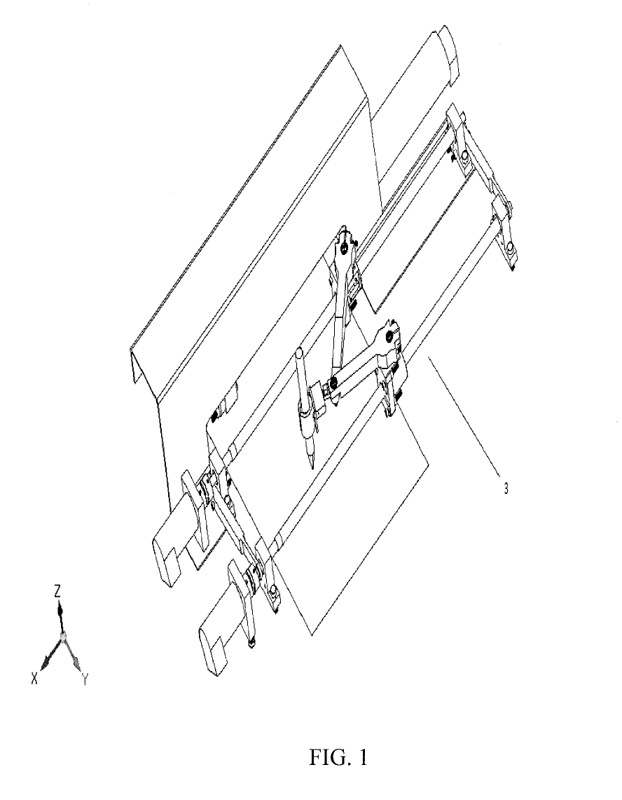

In one embodiment of the present invention, as shown in FIG. 1, the handwriting tool 3 may be linked to a printer. The handwriting system may incorporate a handwriting tool to facilitate the integration or affixing of handwriting to a document. A skilled reader will recognize that the linked printer and handwriting tool may be of several configurations. For example, the handwriting tool may be positioned on top of the printer. This embodiment of the invention is merely meant to illustrate a particular way in which the biometrical printer of the present invention (used to affix the biometrically accurate handwriting) could be integrated with a conventional printer (used to affix the other portions of the document that do not consist of handwriting that is designated for biometrically accurate reproduction). In another embodiment of the present invention, the handwriting tool may be positioned beside the printer, in a manner whereby it may receive the paper copy of any document printed by the printer. A skilled reader will recognize that a variety of configurations of the link between the handwriting tool and the printer may be possible.

It should be understood that the handwriting tool is integrated with the printer mechanism and the printer workflow embodied by the printer mechanism's design, so as to enable the insertion of the biometrically accurate instances of handwriting in appropriate spots in a document printed by the printer mechanism.

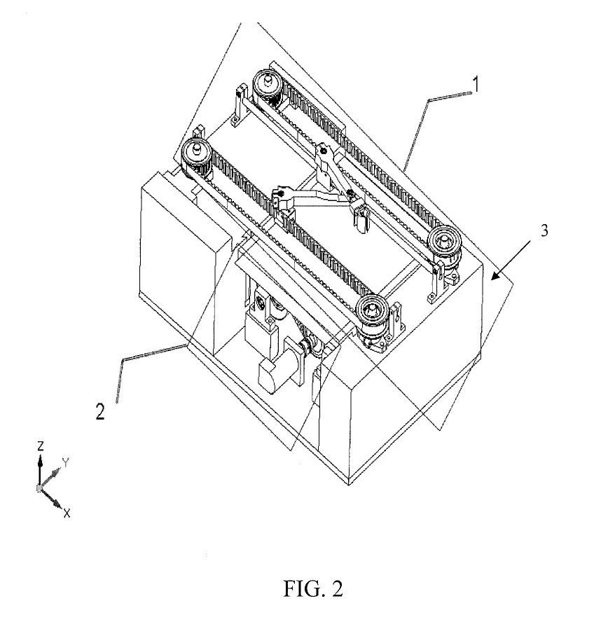

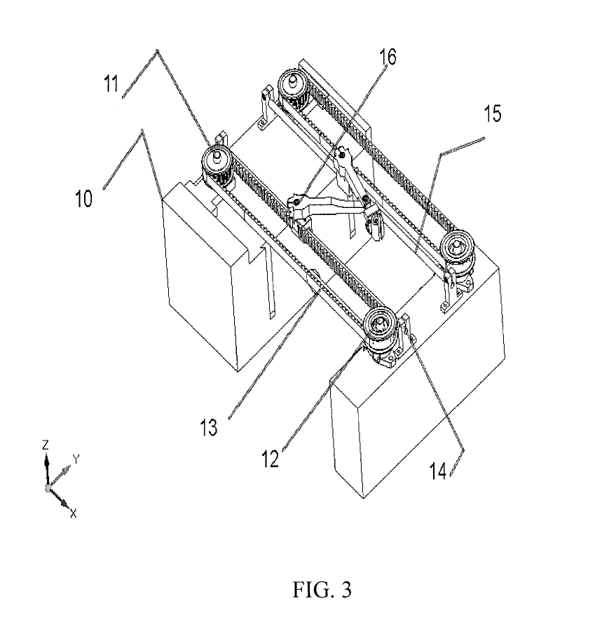

In one embodiment of the present invention, as shown in FIG. 2, the handwriting tool 3 may comprise a handwriting assembly 1, and a lifting assembly. As shown in FIG. 3, the handwriting assembly may incorporate at least one support 10. For example, two supports may be positioned parallel to each other with a space between the supports. One support may incorporate a recess in the top edge. One or more pulleys 11, such as non-backlash pulleys, may be positioned upon the recessed top edge of the support. Each pulley may include a shaft extending in a direction that is upwards from the top edge of the recessed support. A circular disc, having a hole therein which the shaft may be fit through, may encircle the shaft so as to be positioned virtually parallel to the top edge of the support. The shaft may be positioned upon top edge of the recessed support, or upon another positioning means.

One or more other idlers 12 may be positioned on the support facing the support where the pulleys are positioned. Each idler may have include a shaft extending in an upwards position for the top edge of the support. A circular disc having a hole therein which the shaft may fit through may encircle the shaft so as to be positioned virtually parallel to the top edge of the support. An idler may be supported in position by a one or more shaft support means 17 and 14.

As shown, a pulley 11 may be positioned so as to be aligned with an idler 12. A belt, such as a timing belt, may be fitted around and between the idler and pulley. For example, two pulleys may be positioned on the recessed support and two idlers may be positioned on another support positioned parallel to the recessed support. A belt may be fitted around and between one of the pulleys and one of the idlers. Another belt may be fitted around and between the other pulley and the other idler. A handwriting implement holder may be positioned between the two belts and removably attached to the belt by way of a bushing 16.

A linear shaft 15 may further attach the handwriting implement holder to a support means attached to the support. The linear shaft may be formed of a rigid or semi-rigid material, such as steel. The linear shaft may further be positioned parallel to at least one of the belts.

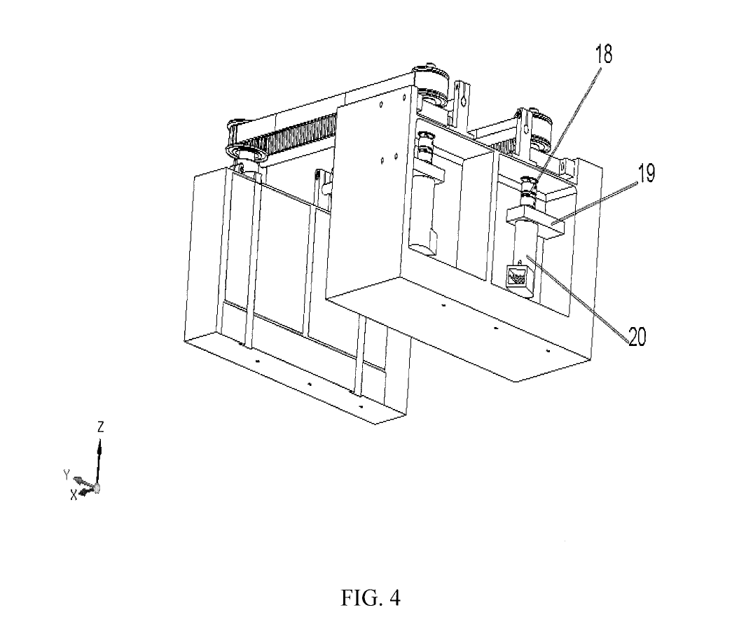

As shown in FIG. 4, a pulley may be attached to a motor 20 by way of a coupling means 18. The motor may held in place by a handwriting motor bracket 19, or another means. The motor 20, may be positioned underneath the pulley within the support, such as in a recessed area or a hollow section of the support. The motor may cause the pulley to rotate. The rotation of the pulley may further cause the belt to move, which in turn may alter the position of the handwriting implement holder. A skilled reader will recognize the range of motion of the belt that may be possible and the variety of directions and speeds the motor at which the may be operable to function.

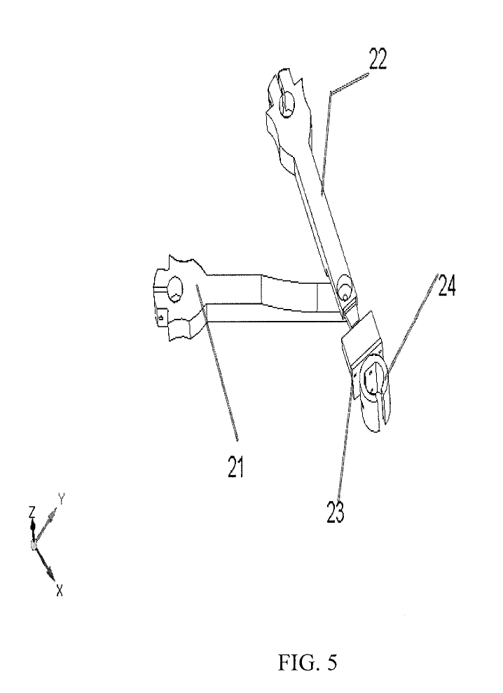

As shown in FIG. 5, the handwriting implement holder may have two arms, for example, such as a linkage arm 21 and a pen arm 22. The arms may intersect at one end and a pen bracket 23 may extend from this intersection point, said pen bracket incorporating a pen holder 24. The pen holder may be capable of holding a writing implement, such as a pen or other writing tool.

The end of the arms of the handwriting implement holder that do not intersect may be removably attached to a linear bushing, as shown in FIG. 3. For example, a bearing may be incorporated in the linking of the arm to the linear bushing to facilitate virtually free rotation of the arm in relation to the linear bushing. A skilled reader will recognize that other means of linking an arm to the linear bushing may be possible.

In this manner the arms of the handwriting implement holder may each be linked by the linear bushing to a belt. As a consequence of this linking, when a motor causes a belt to move, the arm of the handwriting implement holder attached to the moving belt will also be moved. Through the movement of each belt, as caused by specific operation of the motor, the position of the handwriting implement holder may be altered so as to cause any writing implement held in the handwriting implement holder to be positioned at specific locations and to move from that location to another by a specific path.

For example, the belt may be grooved and the bushing may fit within such grooves on the belt. The movement of the belt may cause the grooves in the belt to exert pressure upon the bushing and induce movement in the arm attached to the bushing. A skilled reader will recognize other means of inducing movement in the handwriting implement holder by way of the link between such handwriting implement bolder and the belt may be possible.

In one embodiment of the present invention, a pin may link the handwriting implement holder arms where they intersect. Such a connection may facilitate the rotation of each arm with respect to the other.

In another embodiment of the present invention, two or more motors may operate independently of each other. This may facilitate two-dimensional motion of the handwriting implement holder.

In one embodiment of the present invention, as shown in FIG. 2, a lifting assembly may be positioned between two supports. The lifting assembly may function so as to adjust the height and angle of a writing plane where the handwriting implement held by the handwriting implement holder may cause a handwriting replica to be affixed upon. To facilitate this function, the lifting assembly may be positioned beneath the handwriting implement holder and handwriting implement held therein. For example, if a paper is positioned upon the lifting assembly, the handwriting implement may make marks upon the paper, and such marks may be a handwriting replica as created by the handwriting implement, in accordance with the handwriting strokes created by the handwriting implement as the handwriting implement holder moves due to the operation of the motor and its effect upon the belt.

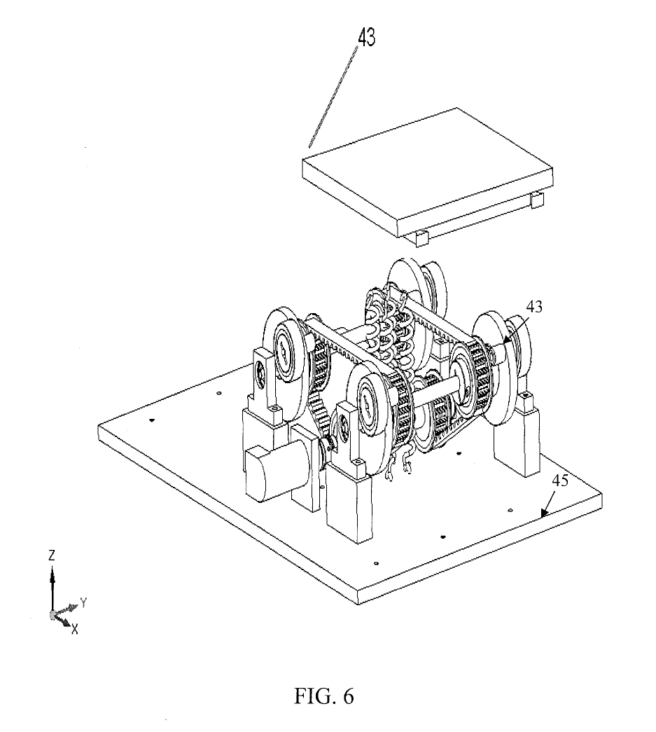

As shown in FIG. 6, the lifting assembly may incorporate a lifting tablet 43 and a lifting mechanism 45. The lifting mechanism may function so as to adjust the height and angle of the lifting tablet. The lifting tablet may be in contact with the writing plane, provide a base for the writing plane, or be the writing plane. A skilled reader will understand that many relationships are possible between the lifting tablet and the writing plane.

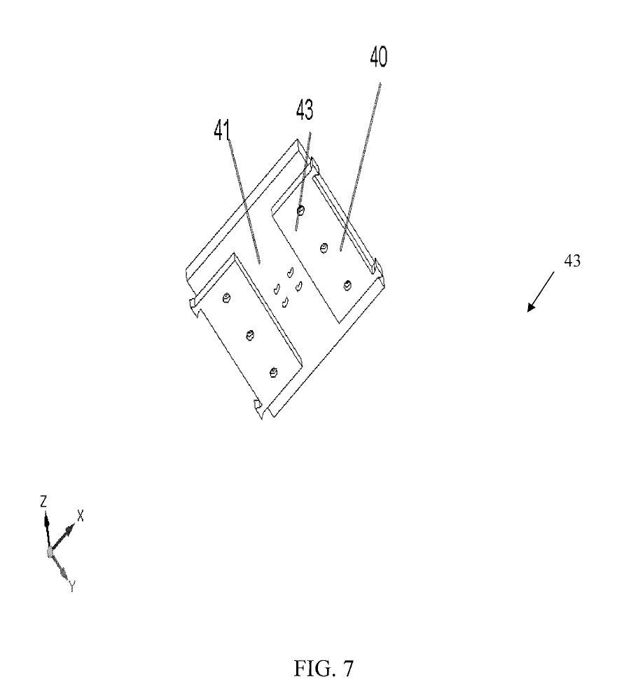

The lifting tablet may incorporate one or more plates. For example, as shown in FIG. 7, a lifting tablet 43, may include one or more side plates 40 and a lift plate 41. The one or more side plates may be removably attached to the underside of the lifting tablet. The lifting tablet may be positioned above the lifting mechanism and may be in contact therewith, so that movement of the lifting mechanism, or movement that is induced by the lifting mechanism, may have the effect of altering the height or the angle of the lifting tablet.

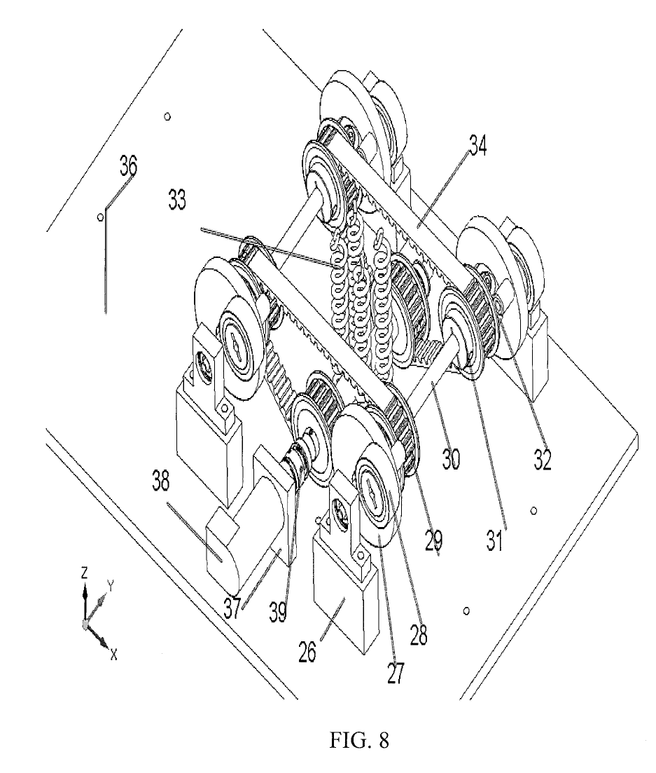

The lifting mechanism, as shown in FIG. 8, may include at least one motor 38 that may drive at least one lifting belt systems 34. A lifting belt system may include a lifting belt that may be linked around and between two lifting pulleys 29, such a non-backlash pulleys. Another motor pulley may be positioned between the two pulleys and said motor pulley may be in contact with the inside of the lifting belt The motor pulley may be connected to a bearing with a housing 39 which may be further connected to a coupling 35. The coupling may be attached to a motor 38. The motor may be held in position in accordance with a lift motor bracket 37.

Two lifting pulleys, that are not of the same lifting belt system, but are positioned virtually parallel to one another, may be coupled by a rotary shaft 30. Said rotary shaft may extend between the two lifting pulleys. The shaft may be attached to a support bearing with a housing 25 which is positioned within a bearing block.

The lifting pulleys may be positioned virtually perpendicular to the base plate of the lifting assembly 36. An inner shaft collar 31 may be positioned on the shaft between the lifting pulleys. The rotary shafts may turn at the same speed. As the shafts turn, a cam follower 28 may rotate along with a disc plate 27 to which said cam follower is rigidly attached. An outer shaft collar 32 may also be positioned on the shaft between the lifting pulley and the cam follower.

As the cam follower may be positioned tangentially in relation to the bottom of the side plate 40, which is connected to the lift plate, the entire lift plate may be able to move in an upward or downward motion, depending on the direction of the rotation. The side plates may fit within slots that may be cut in one or more of the supports. This means of creating a connection between the side plate and the supports may allow the lift plate to be guided in a vertical fashion.

In one embodiment of the present invention, to diminish or eliminate backlash in the lift assembly, the entire mechanism may be preloaded with four springs 33, such as tension springs. Such tension springs may apply a force that virtually continuously facilitates the side plate to be in contact with the cam followers.

A handwriting implement may create strokes or other marks that constitute a handwriting replica upon a paper document positioned upon the lifting tablet. Such strokes may be created in accordance with the movement of the handwriting implement holder and the lifting assembly. As a result the handwriting replica may be biometrically accurate as the strokes may replicate the angle of the handwriting implement and the pressure of the handwriting implement upon the paper at points during the course of handwriting, as well as other nuances, that are produced by handwriting of the individual. This may be achieved through the lifting and lowering of the lifting assembly and the position of the handwriting implement as facilitated by movement of the handwriting implement holder. A skilled reader will recognize that a person skilled in handwriting examination may therefore be able to identify the handwriting replica as the handwriting of a specific individual.

In accordance with the present invention, the handwriting replica may be produced by a pen, and therefore be ink affixed to the document that is distinct from the printer ink utilized to product the document content. A skilled reader will recognize that a variety of inks may be utilized if more than one handwriting replica is to be affixed or integrated with the document content.

In one embodiment of the present invention, the handwriting system including the printer may be linked to a computer, such as, for example via an Ethernet or wireless infrastructure on an IP based network. In another embodiment of the present invention the handwriting system may be directly connected to a “server” computer, such as, for example via a USB, Firewire, or Serial connection. The handwriting system including the printer may include some computing capabilities, such as, for example the capability to read in proprietary data formats and to execute functionality in accordance with that data. The computer may also operate to provide have computing capabilities to the handwriting system, or may operate to provide complementary or supplementary computer capabilities to the handwriting system including the printer to which the computer is connected. This handwriting system may include a driver that permits the computer to communicate with the handwriting system and printer. A skilled reader will recognize that there may be a variety of other methods by which the handwriting system including the printer may be linked to a computer.

The present invention may incorporate a variety of security features to protect the integrity of the handwriting, the document content and the integration of these in the final paper copy of the document. Examples of some of these security features are described herein. However, a skilled reader will recognize that many security features may be applied to the present invention.

In one embodiment of the present invention, a specific printer may be associated with a particular individual. In such an embodiment of the present invention it may be possible to include security features whereby when a paper copy of a document is created that paper copy will only include the handwriting of the individual associated with the printer. In another embodiment of the present invention, a seal or other insignia, may be printed in the place of the handwriting of individuals not associated with the printer, or a seal may replace a portion of the handwriting of other individuals not associated with the printer. Alternatively a seal may be printed in place of the handwriting of all individuals or selected individuals, or may replace a portion of the handwriting of all individuals or selected individuals. These measures may protect the handwriting of individuals from being copied or forged by other individuals in the future.

A seal may be a physical seal, such the image affixed to legal documents as a seal. Alternatively, a seal may be a tag linked to the document, or a date/time stamp that is written into the handwriting. At least one seal may be integrated into particular handwriting, or specific documents, or each document, or only particular documents, or no documents at all. A skilled reader will recognize the variety of possibilities for the integration of seals with handwriting/documents. A seal may generally be identifiable, so as to be easily recognized as indicating a particular instance, such as, for example a particular document or an individual's handwriting. A seal may also be difficult to forge. A seal may be stored as linked to a document or to an individual's handwriting. The seal may therefore be integrated into a paper copy of a document upon the choice of particular settings for the system, method or computer program of the present invention by a user. A seal may be utilized to validate and/or authenticate a document.

In one embodiment of the present invention, the handwriting system may incorporate a distinct file format for capturing handwriting of an individual. Any printer or handwriting tool of the present invention shall be operable to recognize the file format of the handwriting. The system, method and computer program may also be more generally able to recognize the file format of the handwriting, although the necessity for the overall elements of the present invention to recognize the file format of the handwriting will depend upon the configuration of a particular embodiment of the present invention. The handwriting will be linked the document content. The document content may be in a common document file format such as, for example Microsoft Word™. A skilled reader will recognize that documents may be stored in a variety of other file formats. The file format of the handwriting may be visible as integrated with the document content when the electronic document is opened for viewing by a user, such as, for example as may occur for comparison purposes.

In another embodiment of the present invention, the printer may include lock down features. Such lock down features may prevent tampering with the document prior to affixing any handwriting replica thereto or affixing any seal or other insignia thereto.

In yet another embodiment of the present invention, a user may be required to view an electronic version of a document prior to being able to initiate printing of a verified and/or authenticated document. The viewable electronic document may be protected so that it may not be altered, modified or otherwise tampered with in any manner. Moreover, viewing a document may cause the present invention to search for duplicate documents elsewhere in the system. The present invention may prevent duplicate documents from existing as such document may diminish and inhibit reliability of the verification and/or authentication of documents.

A document may be printable to any printer, or may only be printable to a specific printer, in accordance with security settings. A secure printer may be utilized and may be operable to recognize particular commands and verification and/or authentication processes.

Additionally, once printed reference information regarding the printer where the paper copy of the document was printed may be stored as linked to the document. A skilled reader will recognize that other details relating to the creation of the paper copy of the document may be stored as linked to the document as well. For example, if a circumstance occurred during the printing process whereby printing was aborted or interrupted (e.g. a paper jam, etc.), this information should be stored as linked to the document. Such information may be utilized to check for possible tampering and to verify that tampering did not occur to any part of the verified and/or authenticated document. Such checking may occur prior to a document being sent to a printer.

It will be appreciated by those skilled in the art that other variations of the embodiments described herein may also be practiced without departing from the scope of the invention. Other modifications are therefore possible. A skilled reader will recognize that the present invention may be utilized to create paper copies of a variety of documents, such as legal documents, transactional documents, letters, passports, official documents, or any other document that may require that one or more handwriting replicas be affixed to document content, or integrated into document content. The present invention may further be utilized to affix autographs to pictures or other printable materials (e.g. posters, stickers, screenplays, etc.), to integrate signatures onto original artwork, and to integrate annotations with hand-drawn or computer produced architectural plans or schematics.

1. A system for generating documents that can be validated and/or authenticated, characterized in that the system comprises:
(a) at least one computer device configured for:
(i) enabling the creation or retrieval of an electronic document, and
( ii) determining or detecting one or more areas of the electronic document for integration of biometrically accurate handwriting representations of one or more individuals associated with the electronic document for establishing the validation and/or authenticity of the electronic document based on the handwriting of the one or more individuals; and
(b) at least one printer linkable to the computer device, the printer incorporating or being further linked to a handwriting device that is operable to apply to paper biometrically accurate handwriting representations, wherein the computer device, the printer, and the handwriting device are integrated so as to enable the printing of the electronic document such that it includes the biometrically accurate handwriting representations for the one or more individuals in the one or more areas of the electronic document, such that a version of the electronic document that can be validated and/or authenticated is printable.

2. The system of claim 1 characterized in that the at least one computer device is operable to create and store one or more computer files in which the electronic document and the associated biometrically accurate handwriting representations are linked.

3. The system of claim 2 characterized in that the system is operable to store the one or more computer files to a storage medium, for on-demand retrieval of validated and/or authenticated documents.

4. The system of claim 1 characterized in that the system is operable to:
(a) establish and/or access one or more parameters for defining whether the document or associated transaction has been finalized;
(b) initiate the capture of the handwriting of the one or more individuals based on the parameters; and
(c) confirm that the parameters have been met so as to create a version of the electronic document that can validated and/or authenticated.

5. The system of claim 3 characterized in that the one or more computer files are configured to be unalterable and the storage medium is associated with a trusted intermediary for enabling trusted retrieval of validated and/or authenticated documents, and the printing of such documents in a validated and/or authenticated form.

6. The system of claim 1, characterized in that the printer is a secure printer.

7. The system of claim 6, characterized in that the printer is configured so as to:
(a) detect one or more attempts to tamper with the printer, and
(b) based on such detection prevent the printing of validated and/or authenticated documents.

8. The system of claim 1, characterized in that the biometrically accurate handwriting representations are printable in ink.

9. The system of claim 8, characterized in that the associated biometrically accurate handwriting representations are printed in a color that is distinct from the color of the other portions of the electronic document.

10. The system of claim 1, characterized in that each handwriting representation is forensically verifiable as emanating from a single one of the one or more individuals.

11. The system of claim 1, characterized in that the printer is a standard printing output device that integrates the handwriting device.

12. The system of claim 2, characterized in that the at least one computer device is further operable to associated with the one or more computer files a symbol, watermark or other indicia indicating that the associated electronic document can be validated and/or authenticated.

13. The system of claim 12, characterized in that the one or more computer files are configured such that when the electronic document is printed, the printed copy includes the indicia.

14. The system of claim 1, characterized in that the at least one computer includes or is linked to a transaction system so to enable the processing of transactions based on the electronic documents that can be validated and/or authenticated.

15. A handwriting system to produce a paper document having one or more biometrically accurate handwriting replicas integrated therein with document content characterized in that the handwriting system comprises:
(a) at least one printer operable to receive instructions from a computer; and
(b) a handwriting tool linked to said at least one printer and operable to receive instructions from said computer to produce said one or more biometrically accurate handwriting replicas upon the paper document, further comprising;
(i) a handwriting assembly operable to position and move a handwriting implement to produce marks upon the paper document; and
(ii) a lifting assembly operable to position and move a writing tablet upon which the paper document may be positioned while the handwriting implement produces the marks;
wherein the marks produced upon the paper document are the one or more biometrically accurate handwriting replicas.

16. A method for generating documents that can be validated and/or authenticated, characterized in that the method comprises the steps of
(a) accessing an electronic document that includes or is associated with one or more parameters for defining whether the electronic document or associated transaction has been finalized, and one or more of such parameters includes the incorporation into the electronic document or associating with the electronic document, biometrically accurate handwriting representations of one or more individuals associated with the electronic document or associated transaction;
(b) initiating the capture of the handwriting of the one or more individuals based on the parameters, and associating the resulting handwriting representations with the electronic document; and
(c) confirming that the parameters have been met so as to create a version of the electronic document that can be validated and/or authenticated.

17. The method of claim 16, characterized in that the electronic document that can be validated and/or authenticated can be accessed and printed on demand by an authorized printer that includes a handwriting device that is operable to mark a paper document with biometrically accurate handwriting representations.

18. The method of claim 17, characterized each handwriting representation is forensically verifiable as emanating from a single one of the one or more individuals.
